(19) United States
(12) Patent Application Publication
(10) Pub. No.: US 2007/0180701 A1
(43) Pub. Date: Aug. 9, 2007

(54) Self-adjusting pipe cutter

(76) Inventor: Heinz Hutt, Ville St-Laurent (CA)

Correspondence Address: LESPERANCE & MARTINEAU, 1440 WEST, STE-CATHERINE ROOM 700, MONTREAL, QC, H3G1R8, CA

(21) Appl. No.: 11/349,994

(22) Filed: Feb. 9, 2006

(51) Int. Cl. B23D 21/06

(52) U.S. Cl. 30/95

(57) ABSTRACT

A pipe cutter comprising a cutterhead defining a mouth for engaging a pipe to be cut. The cutterhead frame defines an elongated pin-guiding channel. A pin is carried by the cutterhead frame and movable along the pin-guiding channel, carrying, a blade movably connected thereabout. A pin-removal outlet is provided on the cutterhead frame A spring is provided to bias the blade towards a first direction along the elongated pin-guiding channel to force the blade to extend into the cutterhead mouth. A releasable plug is installed on the cutterhead frame, and selectively obstructs the pin-removal outlet for preventing free egress of the pin out of the cutterhead pin-guiding channel through the pin-removal outlet. The plug can be selectively released to allow egress of the pin out of the pin-guiding channel through the pin-removal outlet to release and allow removal of the blade from the cutterhead frame.

### FIELD OF THE INVENTION

The present invention relates to pipe cutters, and more particularly to a self-adjusting pipe cutter.

### BACKGROUND OF THE INVENTION

Plumbers generally use dedicated pipe cutters to transversally severe pipes. Different varieties of pipe cutters are available on the market and all have their pros and cons. Amongst theses varieties, ratchet provided pipe cutters are especially popular due to their ease of use and cutting efficiency. Ratchet-provided pipe cutter generally comprises a handle, to which is rotatably mounted a cutterhead, the rotatable interconnection between the cutterhead and the handle being ratcheted. The cutterhead is generally C-shaped, i.e. it has a generally discoid shape with a U-shaped opening radially made therein and which forms a pipe-cutting mouth. A disc-shaped blade is rotatably mounted to said cutterhead, and extends into the pipe-cutting mouth thereof. Moreover, a pair of rollers are generally provided in the pipe-cutting mouth, diametrically opposite to said disc-shaped blade, against which a pipe will rollably rest while being cut.

The prior art discloses various models of ratchet-provided pipe cutters, comprising the above-described characteristics. However, the configuration of the cutterhead differs between the various ratchet-provided cutters. A well known design of pipe cutter comprises a blade-carrying arm carrying the disc-shaped blade. A knob, linked to the blade carrying arm by a feed screw, can be pivoted to radially displace the blade-carrying arm, and thus radially displace the blade towards or away from the rollers. To use such a pipe cutter, the knob is adjusted so as to to widen the gap between the blade and the rollers, a pipe is inserted in the pipe-cutting mouth between the blade and the roller, and the knob is pivoted in the opposite direction so as bring the blade in pressing engagement on the pipe, thereby pressing the pipe against and between the two rollers. To cut into the pipe, the cutterhead is rotated around the pipe using the handle which rotatably carries the cutterhead. As the whole device is rotated, the blade progressively digs in the material of the pipe, and the knob has to be tightened up from time to time to allow the blade to remain in pressing engagement against the pipe.

To obviate the necessity of having to keep tightening a knob while the cutterhead is being rotated around the pipe, other pipe cutters are provided with a spring-loaded blade which remains biased towards the pair of rollers. In such devices, the blade remains biased towards the pipe inserted in the cutterhead and interposed between the disc-shaped blade and the rollers while the cutterhead is being rotated around the pipe.

However, such spring-loaded pipe cutters are difficult to maintain. Indeed, they comprise a hollow cutterhead into which a number of mechanical parts are nested, and in order to replace the blade, the whole cutterhead must be opened up, which generally causes most of its internal parts to fall out thereof. Most components must therefore be reassembled and put back in position every time the user of the tool wants to replace a worn-out blade by a new one. This can be very annoying, especially for professional plumbers who make extensive use of their pipe cutter and who thus have to replace their blades more frequently.

### SUMMARY OF THE INVENTION

The present invention relates to a pipe cutter comprising:
a cutterhead defining a pipe-cutting mouth for engaging a pipe to be cut, said cutterhead defining a frame in turn defining an elongated pin-guiding channel;
a blade-mounting pin carried by said cutterhead frame and movable along said pin-guiding channel;
a blade defining a pin hole, said blade-mounting pin penetrating said pin hole in order to movably connect said blade to said pin-guiding channel and thus to said cutterhead frame, said blade capable of at least partially extending into said pipe-cutting mouth of said cutterhead;
a biasing member capable of biasing said blade towards a first direction along said elongated pin-guiding channel in order to force said blade to extend into said cutterhead pipe-cutting mouth;
a pin-removal outlet provided on said cutterhead frame and opening into said pin-guiding channel; and
a releasable pin restraining member installed on said cutterhead frame and obstructing said pin-removal outlet for preventing free egress of said blade-mounting pin out of said cutterhead pin-guiding channel through said pin-removal outlet, wherein said pin restraining member can be selectively released to allow egress of said blade-mounting pin out of said pin-guiding channel through said pin-removal outlet to release and allow removal of said blade from said cutterhead frame.

In one embodiment, said pin-removal outlet is a pin-removal aperture made through said cutterhead frame, said pin-removal aperture being slightly broader than said blade-mounting pin.

In one embodiment, said releasable pin restraining member comprises a removable closure member which can selectively obstruct said pin-removal aperture, and which can be selectively removed therefrom to clear said pin-removal aperture and allow extraction therethrough of said blade-mounting pin from said pin-guiding channel.

In one embodiment, said closure member is a plug member removably friction fitted in said pin-removal aperture, and which can be selectively removed from said pin-removal aperture for clearing the latter.

In one embodiment, said cutterhead frame is hollow and defines an inner cavity, said pin-guiding channel being located in said inner cavity, and said blade being at least partially received in said inner cavity.

In one embodiment, said inner cavity defines first and second spaced-apart side walls and a peripheral wall extending transversally between said first and second side walls, said first and second side walls comprising first and second guiding tracks respectively, said first and second guiding tracks registering with each other and forming in combination said pin-guiding channel, a first end portion of said blade-mounting pin being slidably received in said first guiding track and a second end portion of said blade-mounting pin being slidably received in said second guiding track.

In one embodiment, said cutterhead pipe-cutting mouth defines a focus point and said elongated pin-guiding channel defines first and second ends, and the distance between said pipe-cutting mouth focus point and said pin-guiding channel increases as said pin-guiding channel extends from its said second end to its said first end.

In one embodiment, said pin-guiding channel is arcuate.

In one embodiment, said biasing member biases said blade-mounting pin and said blade towards said pin-guiding channel second end.

In one embodiment, said biasing member comprises a spring defining a spring finger in contact with said blade-mounting pin in at least some positions thereof along said pin-guiding channel.

In one embodiment, said spring finger clears said blade-mounting pin when said blade-mounting pin is located about said pin-guiding channel second end.

In one embodiment, said blade is centrally pierced to form said pin hole.

In one embodiment, said pipe cutter further comprises a main body carrying said cutterhead, said main body comprising a handle.

In one embodiment, said main body comprises a double-claw member rotatably carrying said cutterhead, and said double-claw member comprises first ratchet means engaging complementary second ratchet means provided on said cutterhead, such that said cutterhead is unidirectionally lockingly engaged by said double-claw member.

In one embodiment, said pipe cutter further comprises pipe support means carried by said cutterhead frame and arranged in said pipe cutting mouth in facing register with said blade, said pipe support means being for supporting a pipe while it is being cut by said pipe cutter.

In one embodiment, said pipe support means comprise a pair of rollers for rollably supporting a pipe while it is being cut by said pipe cutter.

The present invention also relates to a portable device for transversely cutting a pipe segment, comprising:
a rigid arcuate body, defining a radially outward wall and a radially inward wall;
a handle transversely projecting from an intermediate section of said radially outward wall of said arcuate body, said handle for enabling an operator to manually manipulate said arcuate body;
a knife member;
first means for mounting said knife member to an intermediate section of said radially inward wall of said arcuate body, wherein said knife member is movable both radially relative to said intermediate section of radially inward wall and tangentially relative thereto;
a roller member;
second means for mounting said roller member to a section of said radially inward wall of said arcuate body in opposite register with said knife member; and
biasing means, for biasing said knife member spacedly toward said roller member whereby a pipe-engaging channel is formed between said knife member and said roller member, said pipe-engaging channel being slightly smaller than the external diameter of the pipe segment to be cut under bias from said biasing means, but becoming slightly larger than the external diameter of the pipe segment upon said knife member moving radially outwardly against the bias of said biasing means responsively to engagement by the pipe segment.

In one embodiment, said knife member is discoid, and defines a sharp peripheral cutting edge.

In one embodiment, said portable device further includes ratchet means, cooperating with said knife member in enabling stepwise shearing action against the pipe segment to be cut during reciprocating arcuate movement of said handle relative to said rigid arcuate body of the portable device.

In one embodiment, said portable device further includes quick disconnect means for manual release of said first means for mounting the knife member, said quick disconnect means accessible from the outside of said rigid arcuate body.

### DESCRIPTION OF THE DRAWINGS

In the annexed drawings:

FIG. 1 is a front perspective view of the self-adjusting pipe cutter according to the present invention;

FIG. 2 is a partially exploded, front perspective view at a smaller scale of the pipe cutter of FIG. 1;

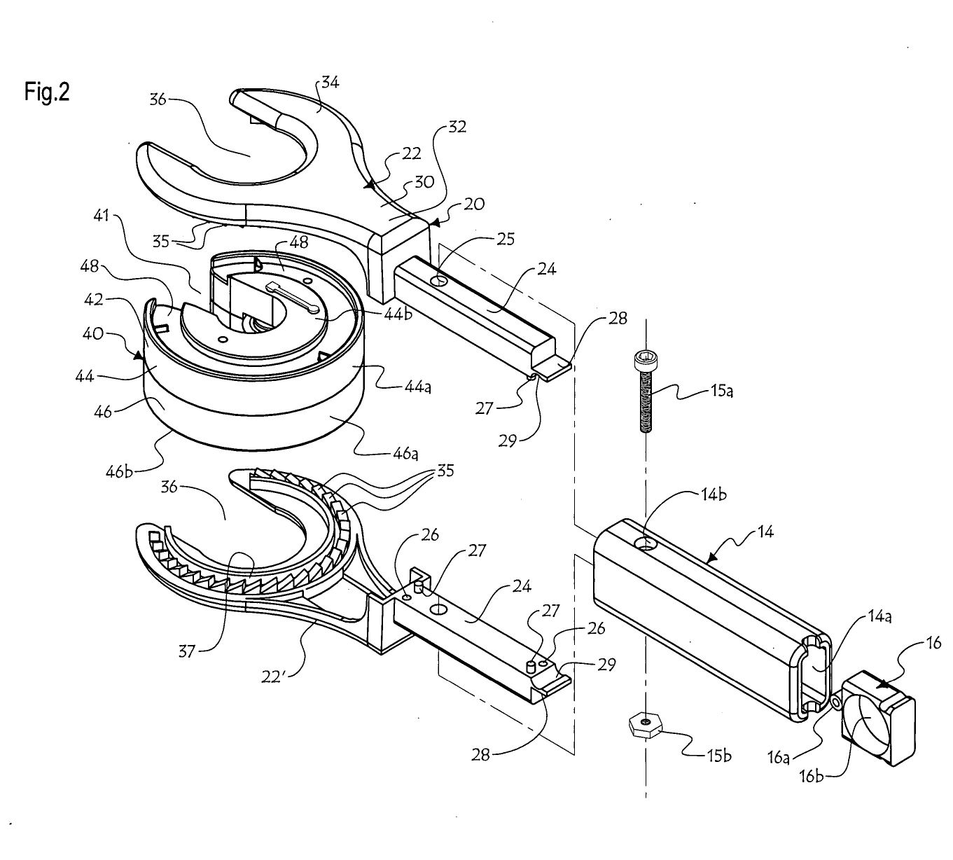

FIG. 3 is an exploded, front perspective view at a smaller scale of the cutterhead of the self-adjusting pipe cutter of FIG. 1;

FIG. 4 is a front perspective view of the assembled cutterhead of the pipe cutter of FIG. 1;

FIG. 5 is a front perspective view of the cutterhead of FIG. 4, showing at a larger scale the two halves of the frame of the cutterhead separated from each other for showing; the inner content of the cutterhead;

FIG. 6 is a top plan view at a smaller scale of one of the two halves forming the frame of the cutterhead of FIG. 4; and

FIG. 7 is a front perspective view similar to that of FIG. 4, with arrows suggesting how can be performed the removal of the blade-mounting pin and of the blade from the cutterhead.

### DETAILED DESCRIPTION OF THE EMBODIMENTS

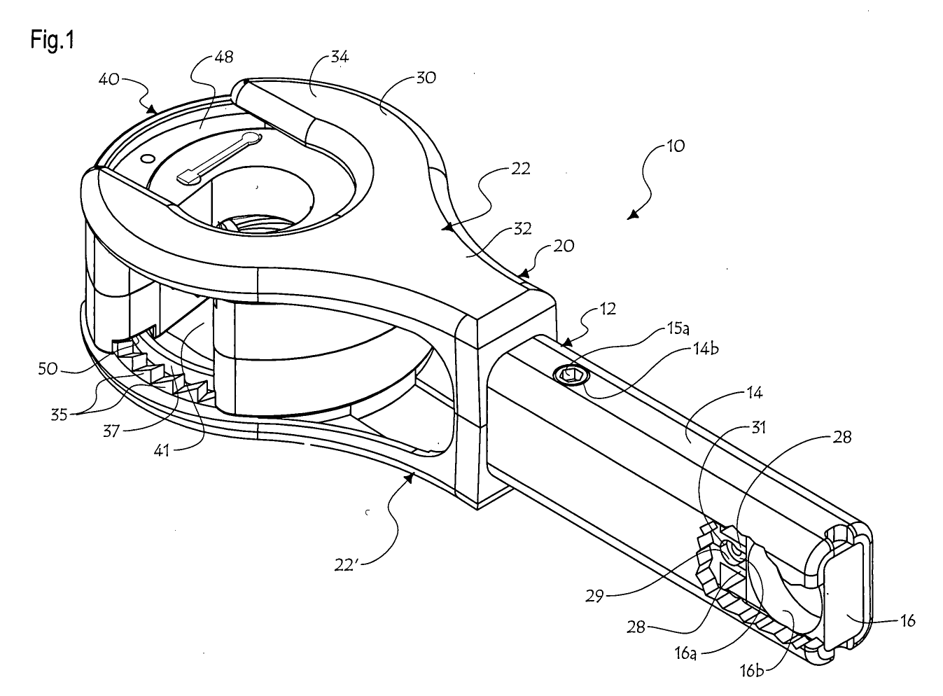

FIG. 1 shows a self-adjusting pipe cutter 10 according to the present invention. Pipe cutter 10 comprises a main body 12, in turn comprising a double-claw member 20 made of metal for example, and composed of two opposite arms 22 and 22′ respectively, arms 22, 22′ carrying a cutterhead 40 as described herein after.

Arms 22 and 22′ are the same in construction, and although only arm 22 will be described hereinafter, arm 22′ has the same structural features and is a mirror image of arm 22, and it is understood that the description of arm 22 applies thereto as well. Arm 22 comprises a parallelepiped-shaped elongated shank portion 24 pierced at hole 25. The facing surfaces of shank portions 24 of arms 22, 22′ each comprise a series of holes 26 made thereon and studs 27 projecting therefrom (with only the holes 26 on arm 22′ being apparent on the drawings and holes 26 on arm 22 being concealed). Moreover, a tongue 28 is provided at one end of shank 24 on each arm 22, 22′, tongue 28 having a rounded recess 29 made on one surface thereof.

When double-claw member 20 is assembled, shanks 24, 24 of arms 22, 22′ are juxtaposed, holes 26 of arm 22 mate with corresponding studs 27 of arm 22′, holes 26 of arm 22′ mate with corresponding studs 27 of arm 22, and holes 25 of shanks 24, 24 of both arms 22, 22′ register together. The coupled shanks 24, 24 penetrate in the lumen 14a of a handle member 14, made of plastic for example, and a screw 15a passing across a hole 14b made transversally on handle member 14, and across registering holes 25, 25 of arms 22, 22′, threadingly cooperates with a nut 15b to secure the handle member 14 to arms 22, 22′. Moreover, when assembled, tongues 28, 28 of both arms 22, 22 unite so that their rounded recesses 29, 29 in combination form a socket 31 (FIG. 1). A selectively removable spare blade holder 16 fits snugly in handle member lumen 14b from the outermost free end thereof, and has an attachment bulge 16a which is complementary to and can be snugly clipped in socket 31 to allow blade holder 16 to fixedly yet releasably remain in handle member lumen 14b. Blade holder 16 comprises a circular recess 16b in which can be stored a spare blade of the type used in cutterhead 40.

Opposite tongue 28, arm 22 comprises a claw 30 integrally connected to shank portion 24. Claw 30 comprises a stem portion 32 merging into a C-shaped rim portion 34, which defines a concavity 36. C-shaped rim portion 34 comprises, on its inner face, an array of edgewisely juxtaposed cross-sectionally triangular ratchet teeth 35, along with a guiding ridge 37 located radially inwardly of the circular array of teeth 35, both the array of teeth 35 and guiding ridge 37 having a general circular-arc shape.

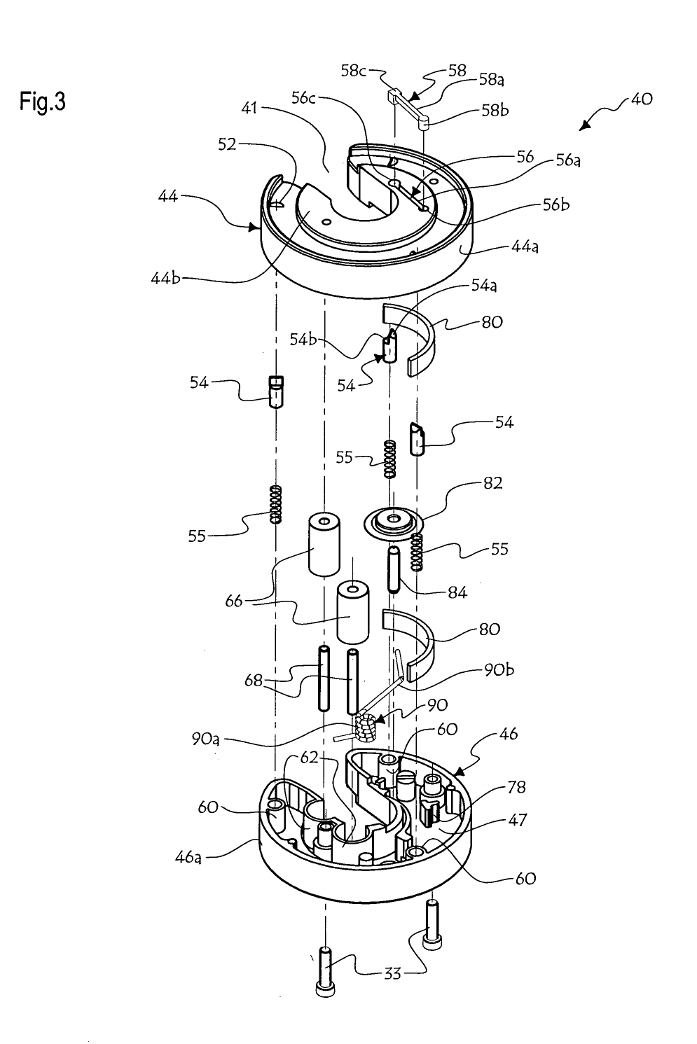

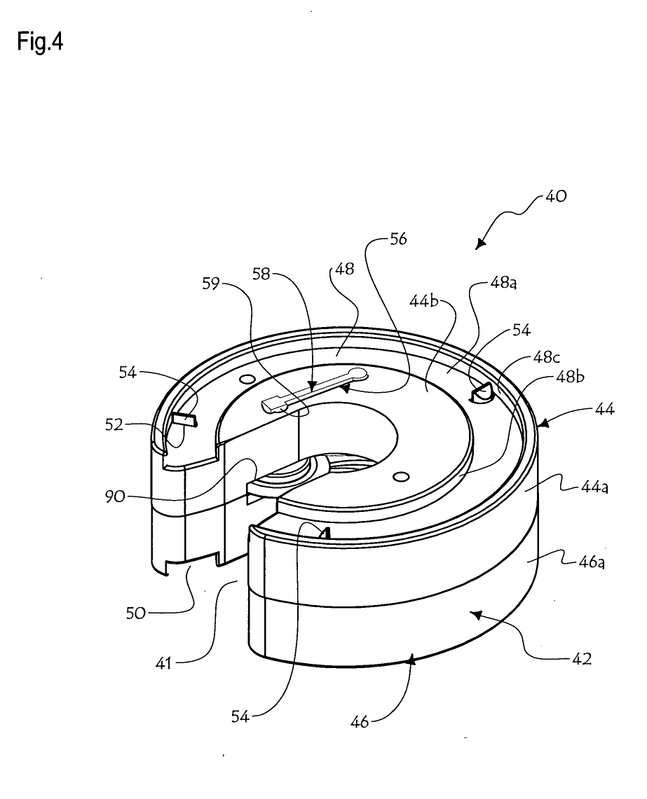

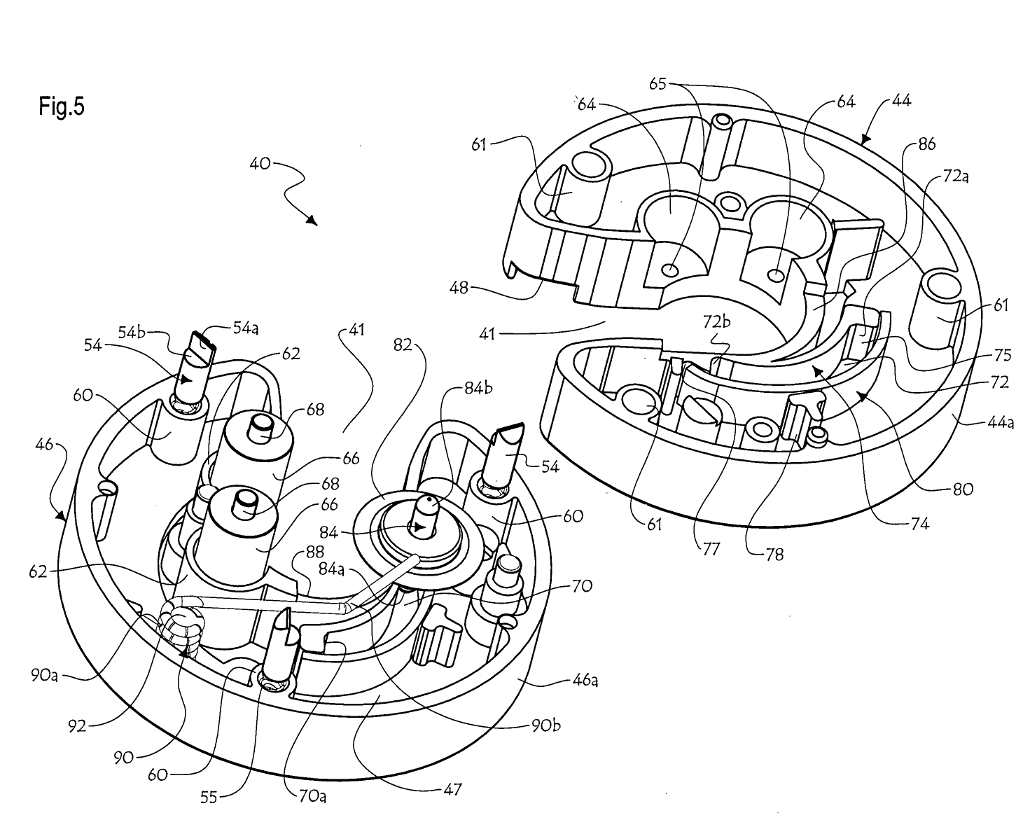

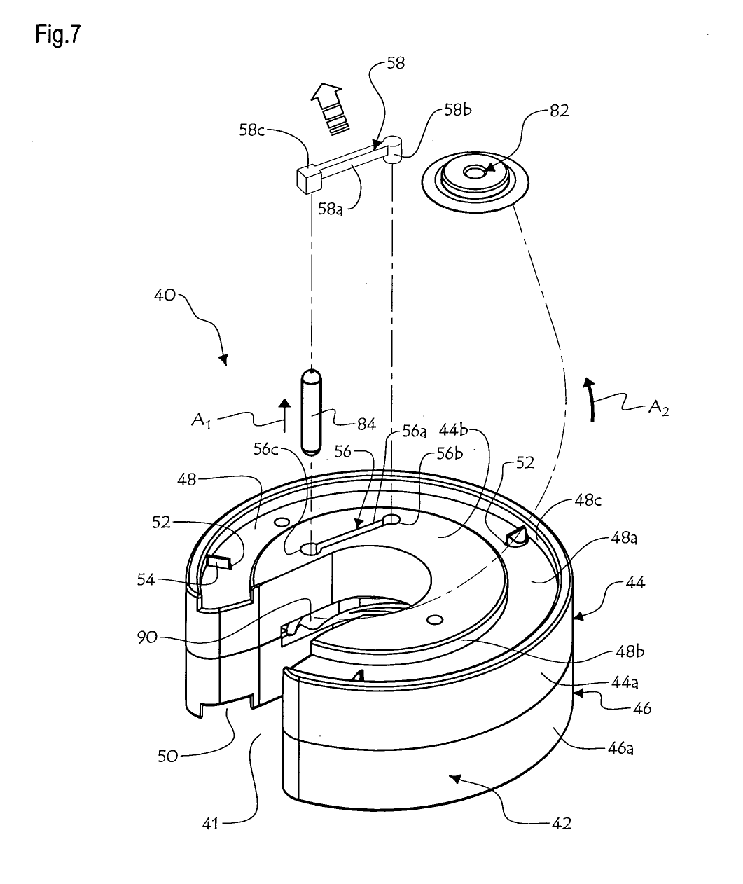

When arms 22, 22′ are assembled, C-shaped rim portions 34, 34 are spaced apart from each other and rotatably carry a C-shaped cutterhead 40 therebetween. Cutterhead 40 defines a pipe-cutting mouth 41 in which a pipe can be inserted in order to be cut as described herein after, and comprises a C-shaped frame 42 composed of two hollow C-shaped frame halves 44, 46, which when assembled enclose an inner cavity 47 (see FIGS. 3 and 5). Each one of halves 44, 46 defines a peripheral wall 44a, 46a respectively, and a side wall 44b, 46b. Each side wall 44b, 46b defines an annular indentation 48, 50 respectively, as best shown in FIGS. 3, 4 and 7. Annular indentation 48, as shown in FIG. 4 and 7, defines a bottom wall 48a, an inner side wall 48b and an outer side wall 48c; annular indentation 50 is for the most part concealed in the figures, but defines similar bottom, inner and outer side walls.

Moreover, one of the two halves (half 44 in the drawings) comprises a number of D-shaped apertures 52 made through annular indentation bottom wall 48a and opening to the inner cavity 47 of cutterhead frame 42, and through which the bevelled tip 54a of a spring-loaded pawl pin 54 retractably protrudes.

Indentations 48, 50 made in frame halves 44, 46 are filled by the circular-arc shaped array of ratchet teeth 35 and guiding ridge 37, and spring loaded pawl pins 54 are biased outwardly so as to unidirectionally lockingly engage ratchet teeth 35. As mentioned above, cutterhead 40 is unidirectionally rotatable relative to arms 22, 22′, and when cutterhead 40 is rotated in a first direction, ratchet teeth 35 of both arms 22, 22′ slide against the bottom wall 48a of annular indentations 48, 50, guiding ridge 37 of both arms 22, 22′ slide against indentation inner side wall 48b, and pawl pins 54 serially engage and slide over ratchet teeth 35 of arms 22, 22′. When rotated in an opposite second direction, bevelled pin tips 54b will lockingly engage ratchet teeth 35 and block relative rotation of cutterhead 40 relative to double-claw member 20.

The unidirectional locking engagement of pawl pins 54 on ratchet teeth 35 thus allows cutterhead 40 to be pivoted relative to arms 22, 22′ in only one pivotal direction, but not in the opposite pivotal direction.

Moreover, one of the frame halves, namely frame half 44, comprises an elongated pin-removal opening 56 made through frame half side wall 44b radially inwardly of annular indentation 48. Pin-removal opening 56 opens into the inner cavity 47 of cutterhead frame 42, and is releasably closed off by an elongated plug 58 snugly friction-fitted therein. On one hand, opening 56 defines an elongated and straight main portion 56a, a circular auxiliary aperture 56b at one end of main portion 56a, and a circular pin-removal aperture 56c at the opposite end of elongated main portion 56a and opening into cutterhead inner cavity 47. On the other end, plug 58 comprises an elongated main portion 58a having complementary dimensions than the main portion 56a of opening 56 and fitting releasably snugly therein, a first round-shaped plug end portion 58b having the same dimensions than auxiliary aperture 56b and fitting snugly therein, and a second plug end portion 58c having a square shape inscribed in the circular pin-removal aperture 56c. The inscription of square-shape plug end portion 58c within circular aperture 56c forms gaps 59 therebetween (see FIG. 4), which will allow a user of pipe cutter 10 to insert a needle, finger nail or other sharp object therein to disengage plug 58 from aperture 56 and selectively clear pin-removal aperture 56c, as described hereinafter.

Inside cutterhead frame inner cavity 47 are nested a number of internal cutterhead components, as best shown in FIGS. 3 and 5.

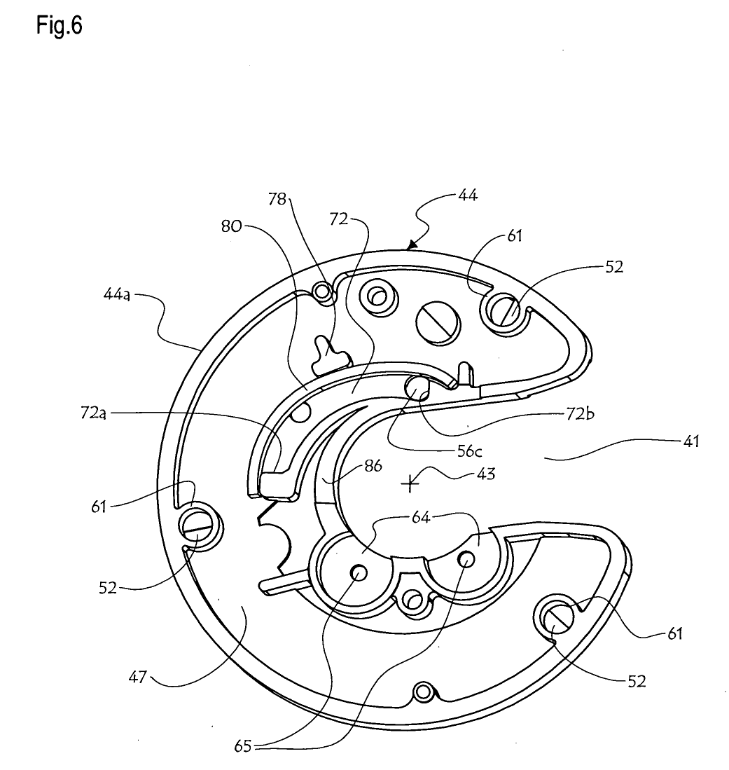

Firstly, as mentioned above, three pawl pins 54 are nested within cutterhead frame inner cavity 47. Each pawl pin 54 is received in a corresponding cylindrical first pawl socket 60 formed on the inner wall of frame half 46, and extends into a corresponding coextensive cylindrical second pawl socket 61 formed on the inner wall of frame half 44. Each cylindrical second pawl socket 61 registers with and surrounds a corresponding D-shaped aperture 50 (see FIG. 6). A coil spring 55 is interposed between the bottom wall (not shown) of first pawl socket 60 and the corresponding pawl pin 54 received therein so as to axially bias it towards socket 61, in order to bias pawl pin tip 54a to extend through aperture 50 outwardly of cutterhead inner cavity 47, and to bias shoulder 54b of pin 54 to come in pressing engagement against the inner bottom wall of socket 61 (not shown).

Moreover, two adjacent yet slightly spaced apart roller sockets 62 are formed on the inner wall of cutterhead half 46; roller sockets 64 are similarly formed on the inner wall of cutterhead half 44 and are coextensive with socket 62 when cutterhead halves 44, 46 are assembled. Each one of roller sockets 62, 64 defines a bottom wall in which a round indentation is made (only indentations 65 made on the bottom wall of roller sockets 64 are shown in the drawings—see FIG. 5). Two pipe-supporting rollers 66, 66 are rotatably carried by corresponding spindles 68, 68 and are lodged between coextensive pairs of roller sockets 62, 64, with both ends of each spindle 68 rotatably received in the round indentations 65 made on the bottom wall of roller sockets 62, 64.

It is noted that each pair of coextensive roller sockets 62, 64, when assembled, in combination form an opening which exposes a peripheral section of cylindrical rollers 66, 66 to pipe-cutting mouth 41.

Cutterhead inner cavity 47 further defines an arcuate pin-guiding channel, formed by the combination of two arcuate guiding tracks 70 and 72 provided on the inner side of cutterhead halves 46 and 44 respectively. Each one of tracks 70 and 72 defines opposite track ends, with only first track end 70a of track 70 and both first and second tracks ends 72a, 72b of track 72 being shown in the drawings (FIG. 5).

In the embodiment of the drawings, tracks 70 and 72 are identical in construction and a description of track 72 will suffice for both. As best seen in FIG. 5, track 72 defines a first longitudinal wall composed of an arcuate flange 74 projecting from and integrally connected to the inner wall of cutterhead frame half 46. A first abutment wall 75 projects transversally from one end of arcuate flange 74 and coincides with track first end 72a, and a second abutment wall 76 is provided at the opposite end of arcuate flange 74 coinciding with track second end 72b. Moreover, adjacently and radially outwardly of second abutment wall 76 is located a rib abutment shoulder 77. Track 72 also comprises an arcuate rib 80, parallel to and located radially outwardly in a spaced apart fashion from arcuate flange 74. Rib 80 rests at one end on the free end of abutment wall 75, rests at its opposite other end against abutment shoulder 77, and is secured in position by a buttress 78 projecting upwardly from the inner wall of cutterhead frame half 44 and forcibly pushing and constraining rib 80 against abutment wall 75 and abutment shoulder 77.

It is noted that flanges 74 and rib 80 are positioned in cutterhead 40 so that the distance between arcuate track 72 and the focus point 43 (see FIG. 5) of pipe cutting mouth 41 is increases as track 72 extends from track second end 72b towards tracks first end 72a.

It has been mentioned above that circular pin-removal aperture 56c of elongated pin-removal opening 56 opens into inner cavity 47. As seen in the plan view of FIG. 7, pin-removal opening 56 opens into arcuate guiding track 72, in the vicinity of track second end 72b.

A disc-shaped blade 82, centrally pierced and penetrated by a blade-mounting pin 84, is slidably mounted along the arcuate pin-guiding channel formed by tracks 70, 72. Indeed a first end 84a of pin 84 is slidably received in track 70, and a second end 84b thereof is slidably received in track 72. Pin 84 has a diameter slightly inferior to that of pin-removal aperture 56c, to enable pin 84 to slide out of cutterhead inner cavity 47 through pin-removal aperture 56c as described hereinafter. Moreover, long crenel-shaped indentations 86, 88 are made on the rim of cutterhead halves peripheral walls 44a, 46b which are in mutual contact when halves 44, 46 are assembled, indentations 86, 88 being made on the section of wall 44a, 46a facing pipe cutting mouth 41 of cutterhead 40. Indentations 86, 88 when united form an elongated slot 90 through which a peripheral section of blade 82 can pass so as to extend into pipe cutting mouth 41 of cutterhead 40.

Moreover, cutterhead 40 further comprises a blade biasing member in the form of a spring 90, defining a coiled portion 90a wrapped around a cylindrical stud 92 extending integrally from the inner wall of cutterhead half 46, and a finger portion 90b extending in the direction of blade-mounting pin 84.

Spring 90 is for biasing blade-mounting pin 84, along with blade 82, towards a rest limit position, where pin 84 is located adjacently to guiding track second end 72b. In this position, pin 84 registers with pin-removal aperture 56c which opens into guiding track 72.

Also, since the distance between the pin-guiding channel and the focus point 43 of the pipe cutting mouth 41 decreases as tracks 70, 72 extend towards their second ends 72b, then blade 82 maximally extends into the pipe-cutting mouth 41 when it is located about the second end 72b of tracks 70, 72. Thus, since spring 90 biases blade 82 towards tracks second ends 72b, spring 90 can be said to bias blade 82 to extend into the pipe-cutting mouth 41 of cutterhead 40.

In the embodiment shown in the figures, spring 90 is configured and positioned to as to release its grip and clear blade-mounting pin 84 when the latter reaches its rest position. This will allow easier removal of pin 84 through pin-removal aperture 56c, as described hereinafter.

To use self-adjusting pipe cutter 10 of the present invention, cutterhead 40 is pivoted relative to double-claw member 20 so that pipe-cutting mouth 41 becomes aligned with concavity 36 of each of claws 34 of arms 22, 22′. A pipe segment (not shown) is then inserted in pipe-cutting mouth 41 of cutterhead 40. As the pipe is inserted inside mouth 41, the pipe will push on blade 82, which will cause blade 82 to leave its rest position, and causing pin 84 to slide against the bias of spring 90 from the second ends of tracks 70, 72 (only track second end 72b being shown in the figures) towards first ends 70a, 72a of tracks 70, 72. As pipe 41 is brought in pipe cutting mouth 41, it eventually comes to abut against and between rollers 66, 66, where it locks in position under the influence of spring-loaded blade 82 continuously pressuring pipe 41 to remain rollably engaged against rollers 66, 66. At this point, the user gets a firm grasp of pipe 41 and starts rotating cutterhead 40 around the pipe in cut-and-crank strokes, with each stroke scoring the peripheral surface of the pipe and radially digging progressively through the thickness of the peripheral wall of the pipe until it is transversally severed. Throughout this process, biasing spring 90 ensures that blade 82 remains firmly radially engaged in the score line being dug in the peripheral wall of the pipe.

As suggested in FIG. 7, with repeated use of pipe cutter 10, cutting edge of blade 82 will eventually become spent due to dulling or chipping, and will need replacement. To replace the blade, the user can grab pipe cutter 10, without any pipe inserted in its pipe-cutting mouth 41, and insert a needle or other sharp object in one of the gaps 59 formed between square-shaped second is plug end portion 58c and circular pin-removal aperture 56c. The user then twists the needle to pry second plug end portion 58c out of the circular pin-removal aperture 56c, therefore clearing and opening the latter. At this point, since no pipe is inserted in pipe-cutting mouth 41 of cutterhead 40, the blade 82 and pin 84 assembly is in its rest position, in which pin 84 registers with the pin-removal aperture 56c. Pin 84 can thus be extracted out of the pin-guiding channel formed by the two guiding tracks 70, 72, by sliding out thereof through pin-removal opening 56c which has just been opened by the removal of plug 58, as illustrated by arrow A₁. The extraction of pin 84 can for example be achieved simply by pivoting pipe cutter 10 around handle 14 until cutterhead frame half 44 faces downwardly towards the ground, in order for pin 84 to freely slide out from the pin-guiding channel through pin-removal aperture 56c under the influence of gravity. As mentioned above, finger 90b of spring 90 does not exert any pressure on pin 84 when it is located in its rest position (see FIG. 5); the free sliding egress of pin 84 out of cutterhead 40 is facilitated in that it is unhindered by friction-borne forces that would likely have been applied on pin 84 by spring 90 if the latter had been pressuring pin 84 against the second ends 70b of tracks 70, 72 when pin 84 is in its rest position.

As pin 84 slides out from guiding tracks 70, 72, it disengages the pin hole of the centrally-pierced blade 82, and causes blade 82 to be released from its connection to cutterhead 40. Thus, when blade-mounting pin 84 is fully extracted from cutterhead 40, blade 82 can be extracted from cutterhead 40 through slot 90, as suggested by arrow A₂ in same FIG. 7.

To finish the blade replacement procedure, a new blade is inserted in elongated slot 90, at the end of elongated slot 90 nearest from the entry of cutterhead mouth opening 41, pin 84 is inserted through pin-removal aperture 56c while passing though the new centrally pierced blade, and plug 58 is snugly reengaged in opening 56.

Alternate embodiments of the present invention could be envisioned without departing from the scope of the present disclosure. For example, the pin-removal outlet (embodied by pin-removal aperture 56c in the above-described embodiment) made in the cutterhead frame could be of any suitable shape and configuration, as long at it permits egress of pin 84 out of the cutterhead pin-guiding channel formed by the combination of tracks 70 and 72. Moreover, it is understood that the elongated plug 58 could be replaced more generally by any suitable releasable pin restraining means, which would prevent the blade-mounting pin from sliding freely out of cutter head 40 through the pin-removal aperture.

These releasable pin restraining means could be any other removable closure means, such as the above-disclosed plug 58 removably blocking pin-removal aperture 56c. Alternately, the pin-removal aperture could be provided with closure means in the form of a sliding cap which can be slidably moved relative thereto to selectively open or close the pin-removal aperture.

In yet another embodiment of the invention, it could be envisioned that these releasable pin restraining means be fixed, as opposed to being removable. For example, instead of having a removable closure means selectively obstructing the pin-removal aperture, a stretchable annular membrane could be installed peripherally around the pin-removal aperture. At rest, this membrane would define a central opening narrower than the pin, thus preventing free egress of the blade-mounting pin outwardly of the cutterhead inner cavity. To extract the pin out of the cutterhead's inner cavity, another opening narrower than the blade-mounting pin could be made on the half of the cutterhead opposite the one in which the pin-removal aperture is made, this other opening registering with the pin when it lays in its rest position. The user of the pipe cutter could then insert a sharp object in this other opening to push the pin towards the hole of the annular stretchable membrane, causing the annular membrane to be released, i.e. causing its annular membrane's opening to yieldably stretch and accommodate passage of the blade-mounting pin therethrough.

In the above-described embodiment, spring finger 90b selectively exerts a biasing force on pin 84 in order to bias blade 82 and pin 84 towards their rest position. In alternate embodiment, it is understood that spring 90 could be replaced by any suitable biasing member. Furthermore, the biasing member could exert a biasing force on either the blade, the pin, or both, in order to bias them towards their rest position.

Moreover, the pair of rollers 66, 66 could be replaced by any other suitable pipe support means arranged in the pipe-cutting mouth in facing register with the blade. Alternately, blade support means could be absent from the present invention, and its function substituted by a suitable concavity formed in the cutterhead pipe-cutting mouth, against which the pipe would be supported and would frictionally slide while the pipe is being cut. Blade 82 could also be of any other suitable shape instead of being discoid, as long as it is carried by a blade-mounting pin.

All embodiment of the present invention have the advantage of obviating the need to disassemble the cutterhead halves in order to replace the blade. Indeed, all that the user needs to do to remove an old, worn-out blade is to remove the blade-mounting pin through the pin-removal aperture, replace the blade, and insert the blade-mounting pin back into the cutterhead through the pin-removal aperture.

1-16. (canceled)

17. A portable device for transversely cutting a pipe segment, comprising:
a rigid arcuate body, defining a radially outward wall and a radially inward wall;
a handle transversely projecting from an intermediate section of said radially outward wall of said arcuate body, said handle for enabling an operator to manually manipulate said arcuate body;
a knife member;
first means for mounting said knife member to an intermediate section of said radially inward wall of said arcuate body, wherein said knife member is movable both radially relative to said intermediate section or radially inward wall and tangentially relative thereto;
gravity borne quick disconnect means, for manual release solely under the influence of gravity of said first means for mounting the knife member, said quick disconnect means accessible from the outside of said rigid arcuate body;
a roller member;
second member for mounting said roller member to a section of said radially inward wall of said arcuate body in opposite register with said knife member; and
biasing means, for biasing said knife member spacedly toward said roller member whereby a pipe-engaging channel is formed between said knife member and said roller member, said pipe-engaging channel being slightly smaller than the external diameter of the pipe segment to be cut under bias from said biasing means, but becoming slightly larger than the external diameter of the pipe segment upon said;
knife member moving radially outwardly against the bias of said biasing means responsively to engagement by the pipe segment.

18. A portable device us in claim 17,
wherein said knife member is a discoid blade, and defines a sharp peripheral cutting edge;
and wherein said first means for mounting includes a cavity made in a first portion of said inward wall of said rigid arcuate body, said cavity having a pin removal outlet, a blade mounting pin releasably engaged into said cavity through said pin removal outlet and centrally penetrating said blade, wherein said pin is slidable freely outwardly from said cavity through said pin removal aperture solely under the influence of gravity upon said rigid arcuate body being tilted so that said pin removal outlet is brought to face downwardly toward ground.

19. A portable device as in claim 18,
further including [ratchet means, cooperating with said knife member in enabling stepwise shearing action against the pipe segment to be cut during reciprocating arcuate movement of said handle relative to said rigid arcuate body of the portable device,]
a pin restraining means, releasable closing said pin removal outlet of said pin removal outlet.

20. A portable device as is claim 19,
[further including quick disconnect means for manual release of said first means for mounting the knife member, said quick disconnect means accessible from the outside of said rigid arcuate body,]
wherein said pin restraining means is a plug releasably closing said pin removal outlet in friction-fit fashion.
